(19) United States
(12) Patent Application Publication
(10) Pub. No.: US 2022/0321711 A1
(43) Pub. Date: Oct. 6, 2022

(54) IMAGE FORMING SYSTEM, STORAGE MEDIUM, AND IMAGE FORMING APPARATUS

(71) Applicant: KYOCERA Document Solutions Inc., Osaka (JP)

(72) Inventors: Tomohiro OGAWA, Osaka-shi (JP); Yoshiteru NISHIKAWA, Osaka-shi (JP)

(73) Assignee: KYOCERA Document Solutions Inc., Osaka (JP)

(21) Appl. No.: 17/704,497

(22) Filed: Mar. 25, 2022

(30) Foreign Application Priority Data
Mar. 30, 2021 (JP) 2021-057164

(51) Int. Cl. H04N 1/00; G06F 3/14

(52) U.S. Cl. CPC H04N 1/00129; H04N 1/00244; H04N 1/00413; H04N 1/00474; G06F 3/1454; H04N 1/00209; H04N 2201/0075; H04N 2201/0091

(57) ABSTRACT

An image forming system includes an image forming apparatus and an information processing device. The image forming apparatus includes an apparatus display section which displays an image. The information processing device includes: a terminal display section which displays an image; a terminal transmission section which transmits remote input information to the image forming apparatus; a terminal reception section which receives remote output information from the image forming apparatus that received the remote input information; and a terminal controller which controls the terminal display section based on the remote output information. The terminal controller controls the terminal display section so as to display an image exhibiting the setting item information in a first region of the terminal display section and display an image exhibiting the related information in a second region of the terminal display section.

### INCORPORATION BY REFERENCE

The present application claims priority under 35 U.S.C. § 119 to Japanese Patent Application No. 2021-057164, filed on Mar. 30, 2021. The contents of this application are incorporated herein by reference in their entirety.

### BACKGROUND

The present disclosure relates to an image forming system, a storage medium, and an image forming apparatus.

A system has been proposed which links an image processing device to a mobile terminal apparatus. In the linking system, an operation screen on an image processing device side for using the functions of the image processing device is displayed as a remote screen on a display section of the mobile terminal apparatus, and the image processing device can be operated in a linked manner from the mobile terminal apparatus.

### SUMMARY

An image forming system according to an aspect of the present disclosure includes an image forming apparatus and an information processing device. The information processing device communicates with the image forming apparatus. The image forming apparatus includes an apparatus display section which displays an image. The information processing device includes: a terminal display section which displays an image; a terminal transmission section which transmits remote input information to the image forming apparatus; a terminal reception section which receives remote output information from the image forming apparatus that received the remote input information; and a terminal controller which controls the terminal display section based on the remote output information. The remote input information includes information which requests setting item information displayed by the apparatus display section and related information related to the setting item information. The setting item information includes information which controls the image forming apparatus. The remote output information includes the setting item information and the related information. The terminal controller controls the terminal display section so as to display an image exhibiting the setting item information in a first region of the terminal display section and display an image exhibiting the related information in a second region of the terminal display section.

A non-transitory computer-readable storage medium according to another aspect of the present disclosure stores a computer program therein. The computer program causes a computer that communicates with an image forming apparatus to execute: transmitting remote input information to the image forming apparatus; receiving remote output information from the image forming apparatus that received the remote input information; and controlling a terminal display section based on the remote output information. The remote input information includes information which requests setting item information displayed by an apparatus display section of the image forming apparatus and related information related to the setting item information. The setting item information includes information which controls the image forming apparatus. The remote output information includes the setting item information and the related information. In the controlling, an image exhibiting the setting item information is displayed in a first region of the terminal display section and an image exhibiting the related information is displayed in a second region of the terminal display section.

An image forming apparatus according to yet another aspect of the present disclosure includes: an image forming section which forms an image; an apparatus controller which outputs setting item information; an apparatus display section which displays the setting item information; an apparatus reception section which receives remote input information from an information processing device; and an apparatus transmission section which transmits remote output information to the information processing device that received the remote input information. The information processing device includes a terminal display section which has a first region and a second region. The remote input information includes information which requests the setting item information displayed by the apparatus display section and related information related to the setting item information. The setting item information includes information which controls the image forming section. The remote output information includes an image exhibiting the setting item information displayed in the first region of the terminal display section and an image exhibiting the related information displayed in the second region of the terminal display section.

### BRIEF DESCRIPTION OF THE DRAWINGS

FIG. 1 is a diagram illustrating a configuration of an image forming system according to a first embodiment of the present disclosure.

FIG. 2 is a diagram illustrating the configuration of an image forming apparatus of the first embodiment.

FIG. 3 is a diagram illustrating an image displayed by an apparatus display section according to the first embodiment.

FIG. 4 is a diagram illustrating a function of a terminal controller of a terminal device according to the first embodiment.

FIG. 5 is a diagram illustrating an image displayed by the apparatus display section of the first embodiment.

FIG. 6 is a flowchart depicting a display method performed by the terminal controller of the first embodiment.

FIG. 7 is a diagram illustrating an image displayed by the apparatus display section according to a second embodiment of the present disclosure.

FIG. 8 is a diagram illustrating an image displayed by the apparatus display section according to a third embodiment of the present disclosure.

FIG. 9 is a diagram illustrating an image displayed by the apparatus display section according to a fourth embodiment of the present disclosure.

### DETAILED DESCRIPTION

The following describes embodiments of the present disclosure with reference to the accompanying drawings. Note that elements that are the same or equivalent are labeled the same reference signs in the drawings and description thereof is not repeated.

### First Embodiment

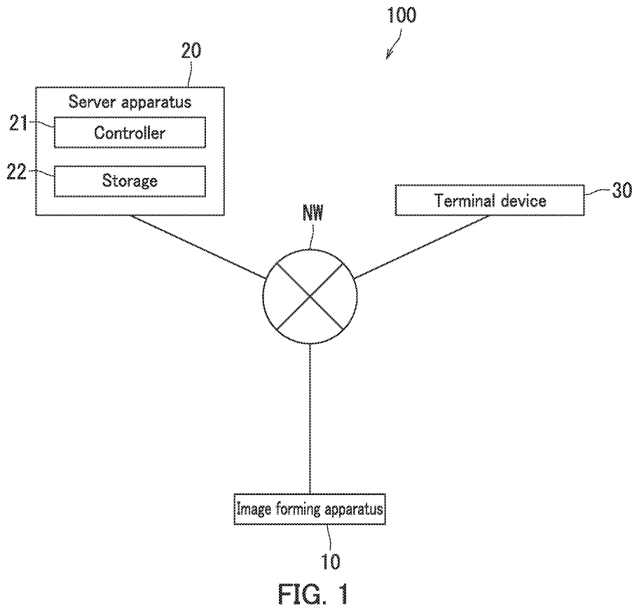

A configuration of an image forming system 100 according to a first embodiment of the present disclosure is described with reference to FIG. 1. FIG. 1 is a diagram illustrating the configuration of the image forming system 100. The image forming system 100 includes an image forming apparatus 10, a server apparatus 20, and a terminal device 30. The image forming apparatus 10, the server apparatus 20, and the terminal device 30 communicate with each other through a network NW. Examples of the network NW include the Internet, a wide-area network (WAN), and a local-area network (LAN).

Examples of the terminal device 30 include a personal computer, a tablet terminal, and a smartphone. The terminal device 30 is an example of an “information processing device” and a “computer”. The terminal device 30 belongs to a service company which performs maintenance on the image forming apparatus 10, for example. The terminal device 30 is operated by a service person of the service company.

The server apparatus 20 includes a personal computer, for example. The server apparatus 20 is an example of an “information processing device” and a “computer”. The server apparatus 20 receives remote input information from the terminal device 30 and remotely connects to the terminal device 30 and the image forming apparatus 10. Specifically, the server apparatus 20 includes a controller 21 and storage 22. The controller 21 includes a central processing unit (CPU), for example. The storage 22 includes semiconductor memory, for example, and may also include a hard disk drive (HDD). The storage 22 is an example of a non-transitory computer-readable storage medium to which a computer program is recorded.

The image forming apparatus 10 is a color copier, for example. The image forming apparatus 10 belongs to a different location other than the service company. The image forming apparatus 10 is operated by a plurality of users.

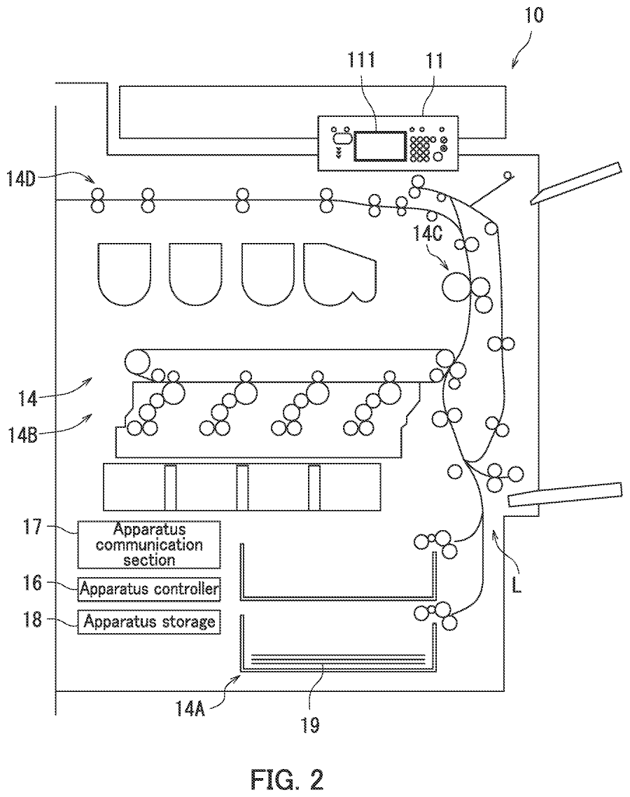

Continuing, the image forming apparatus 10 of the first embodiment is described with reference to FIG. 2. FIG. 2 is a diagram illustrating the configuration of the image forming apparatus 10. As illustrated in FIG. 2, the image forming apparatus 10 forms an image on a sheet 19.

The image forming apparatus 10 includes an operation display section 11, an image forming section 14, an apparatus communication section 17, an apparatus controller 16, and apparatus storage 18. The apparatus communication section 17 is an example of an “apparatus transmission section” and an “apparatus reception section”.

The image forming section 14 includes a sheet feed section 14A, a conveyance section L, a forming section 14B, a fixing section 14C, and an ejection section 14D. The sheet feed section 14A feeds the sheet 19 to the conveyance section L. The conveyance section L conveys the sheet 19 to the ejection section 14D via the forming section 14B and the fixing section 14C.

The forming section 14B electrographically forms an image on the sheet 19. The fixing section 14C applies heat and pressure to the sheet 19 to fix the image formed on the sheet 19 to the sheet 19. The ejection section 14D ejects the sheet 19 out of the image forming apparatus 10.

The operation display section 11 receives operation from the users and displays various information. The operation display section 11 includes an apparatus display section 111. The apparatus display section 111 includes a liquid-crystal display (LCD) and a touch sensor, for example.

The apparatus communication section 17 performs communication following a communication standard such as a network interface controller (NIC) or Wi-Fi, for example. The NIC performs communication according to a prescribed communication protocol. The prescribed communication protocol is the Transmission Control Protocol/Internet Protocol (TCP/IP) suite (i.e., the Internet protocol suite), for example.

The apparatus storage 18 includes semiconductor memory, and may include an HDD.

The apparatus controller 16 includes a CPU, for example. The apparatus controller 16 controls the image forming apparatus 10 based on setting item information. The setting item information includes information which controls the image forming apparatus 10. Specifically, the apparatus controller 16 controls the image forming apparatus 10 based on a plurality of pieces of the setting item information. Examples of the pieces of the setting item information include “Message Language”, “Date setting”, “Buzzer”, “RAM Disk Mode”, “Error Handling”, and “ColorToner Empty”.

In detail, the setting item information includes information indicating one piece of selection candidate information selected from among a plurality of pieces of selection candidate information. Specifically, each piece of the setting item information is set to one piece of the selection candidate information selected from among the pieces of the selection candidate information. More specifically, the setting item information is set with the selection candidate information by the service person at a prescribed time. For example, when the setting item information indicates “Message Language”, the pieces of the selection candidate information include “English”, “Français”, “Deutsch”, “Italiano”, “Nederlands”, and “Español”.

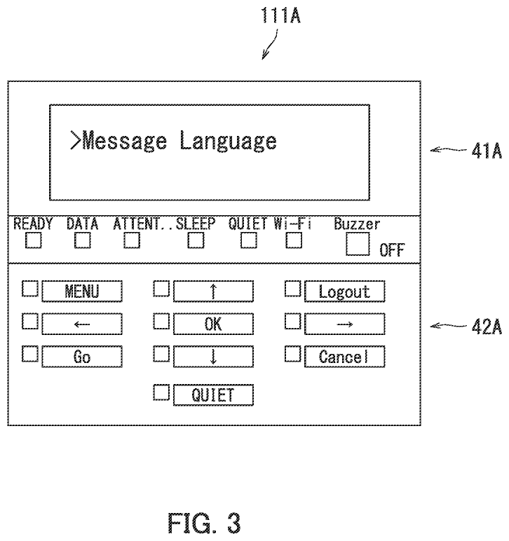

Continuing, an image displayed by the apparatus display section 111 based on the setting item information is described with reference to FIG. 3. FIG. 3 is a diagram illustrating an image 111A displayed by the apparatus display section 111. As illustrated in FIG. 3, the image 111A includes an image 41A exhibiting the setting item character information, and an operation image 42A.

The image 41A exhibiting the setting item character information includes “Message Language”, for example. Specifically, the image 41A exhibiting the setting item character information is displayed by a two-line printer panel.

The operation image 42A includes a “MENU” button, an “up arrow” button, a “Logout” button, a “left arrow” button, an “OK” button, a “right arrow” button, a “GO” button, a “down arrow” button, a “Cancel” button, and a “QUIET” button.

For example, the service person goes to the location where the image forming apparatus 10 is arranged. The service person then uses the “up arrow” button and the “down arrow” button on the image forming apparatus 10 to select “English” from among “English”, “Français”, “Deutsch”, “Italiano”, “Nederlands”, and “Español”, thus causing the apparatus display section 111 to display character information in “English”.

Each piece of the setting item information is classified into one piece of classification information among a plurality of pieces of classification information. Examples of the pieces of the classification information include “Report Print”, “USB Memory”, “Counter”, “Paper Settings”, “Print Settings”, “Wired Network”, “Network Settings”, “Device Common”, and “Adjust/Maintenance”. For example, “Message Language”, “Date setting”, “Buzzer”, “RAM Disk Mode”, “Error Handling”, and “ColorToner Empty” are classified as “Device Common”.

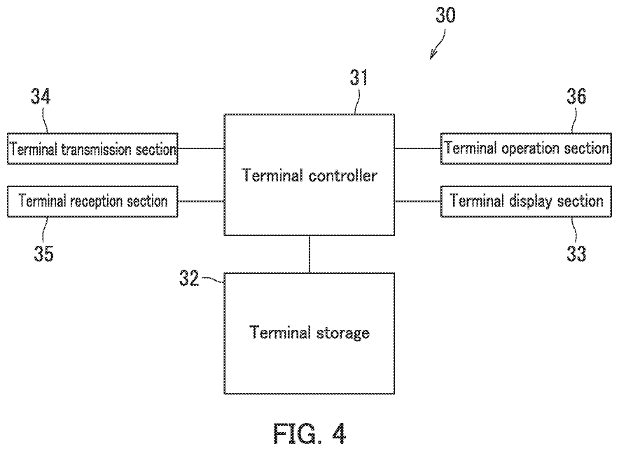

Continuing, the function of the terminal device 30 of the first embodiment is described with reference to FIG. 4. FIG. 4 is a diagram illustrating the function of a terminal controller 31 of the terminal device 30. As illustrated in FIG. 4, the terminal device 30 includes a terminal display section 33, the terminal controller 31, terminal storage 32, a terminal transmission section 34, a terminal reception section 35, and a terminal operation section 36.

The terminal storage 32 includes semiconductor memory, for example, and may include an HDD. The terminal storage 32 is an example of a non-transitory computer-readable storage medium to which a computer program is recorded. Specifically, the terminal storage 32 stores an application program (may be referred to below as an “application AP”), a computer program, and data. The application AP is an example of a “computer program”.

The terminal controller 31 includes a CPU, for example. Specifically, the terminal controller 31 reads out the application AP from the terminal storage 32 and executes the application AP.

The terminal transmission section 34 transmits the remote input information to the image forming apparatus 10. In other words, the application AP causes the terminal transmission section 34 to perform transmitting of the remote input information to the image forming apparatus 10. Specifically, the terminal transmission section 34 transmits the remote input information to the image forming apparatus 10 through the server apparatus 20 based on a result of operation of the terminal operation section 36. The remote input information includes a signal requesting a line connection between the terminal transmission section 34 and the image forming apparatus 10 so that a remote screen can be shared between the terminal transmission section 34 and the image forming apparatus 10.

Specifically, the remote input information includes information which requests the setting item information displayed by the apparatus display section 111 of the image forming apparatus 10. More specifically, the setting item information includes the image 41A exhibiting the setting item information, and the operation image 42A.

The remote input information includes information which requests related information. The related information includes information related to the setting item information. Examples of the related information include a plurality of pieces of the setting item information classified into the same piece of the classification information. For example, when the setting item information indicates “Message Language”, the related information includes “Message Language”, “Date setting”, “Buzzer”, “RAM Disk Mode”, “Error Handling”, and “ColorToner Empty” which are classified as “Device Common”.

The terminal reception section 35 receives the remote output information from the image forming apparatus 10 which received the remote input information. In other words, the application AP causes the terminal reception section 35 to perform receiving of the remote output information from the image forming apparatus 10. Specifically, the terminal reception section 35 receives the remote output information from the image forming apparatus 10 through the server apparatus 20. The remote output information includes the setting item information and the related information.

The terminal display section 33 is a display, for example. The display may include a touch sensor. The size of the terminal display section 33 is larger than the size of the operation display section 11. The shape of the terminal display section 33 also differs from the shape of the operation display section 11.

The terminal controller 31 controls the terminal display section 33 based on the remote output information. In other words, the application AP causes the terminal controller 31 to perform controlling of the terminal display section 33 based on the remote output information.

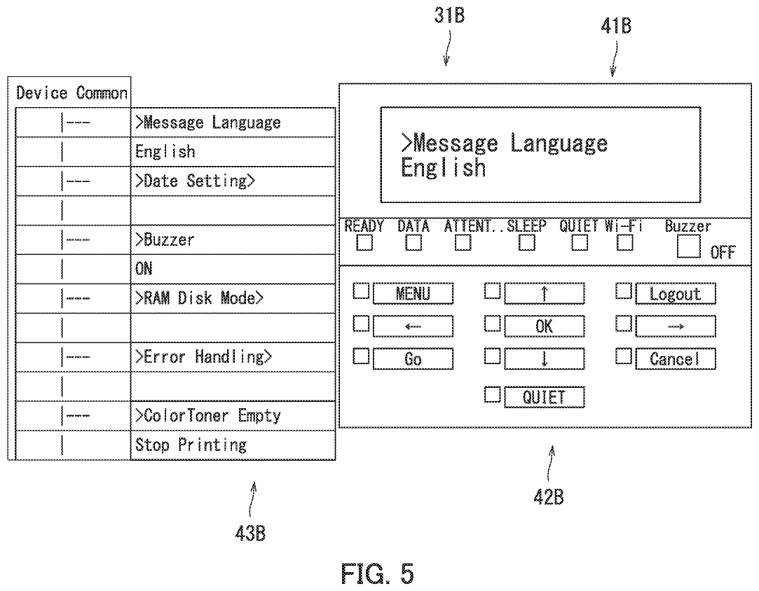

Continuing, an image displayed by the terminal display section 33 based on the remote output information is described with reference to FIG. 5. FIG. 5 is a diagram illustrating an image displayed by the terminal display section 33. As illustrated in FIG. 5, an image 31B includes an image 41B exhibiting the setting item character information, and an operation image 42B. The image 31B further includes an image 43B exhibiting the related information.

The terminal controller 31 displays the image 41B exhibiting the setting item character information and the operation image 42B in a first region of the terminal display section 33. Specifically, the shape of the apparatus display section 111 is substantially the same as the shape of the first region of the terminal display section 33.

The image 41B exhibiting the setting item character information includes “Message Language”, for example.

The operation image 42B includes a “MENU” button, an “up arrow” button, a “Logout” button, a “left arrow” button, an “OK” button, a “right arrow” button, a “GO” button, a “down arrow” button, a “Cancel” button, and a “QUIET” button.

The image 43B exhibiting the related information is displayed in a second region of the terminal display section 33. Specifically, the first region of the terminal display section 33 differs from the second region of the terminal display section 33. More specifically, the second region of the terminal display section 33 is arranged to the left of the first region of the terminal display section 33. The image 43B exhibiting the related information is a list including a plurality of pieces of the setting item information classified into the same piece of the classification information, for example.

The list including the pieces of the setting item information includes “Message Language”, “Date setting”, “Buzzer”, “RAM Disk Mode”, “Error Handling”, and “ColorToner Empty”. “Message Language”, “Date setting”, “Buzzer”, “RAM Disk Mode”, “Error Handling”, and “ColorToner Empty” therefore belong to “Device Common”.

According to the first embodiment as illustrated in FIG. 5 as described above, the terminal controller 31 displays the images 41B and 42B exhibiting the setting item information in the first region of the terminal display section 33, and displays the image 43B exhibiting the related information in the second region of the terminal display section 33. As a result, the service person can perform maintenance on the image forming apparatus 10 while they are at the service company. Furthermore, the service person can efficiently perform maintenance on the image forming apparatus 10 while confirming the image 43B exhibiting the related information displayed in the second region of the terminal display section 33. Therefore, the second region of the terminal display section 33 can be used efficiently.

The shape of the apparatus display section 111 is substantially the same as the shape of the first region of the terminal display section 33. As a result, the service person can efficiently perform maintenance on the image forming apparatus 10 while confirming the images 41B and 42B exhibiting the same setting item information as the images 41A and 42A exhibiting the setting item information displayed by the apparatus display section 111.

In addition, the image 43B exhibiting the related information is a list including a plurality of pieces of the setting item information classified into the same piece of the classification information. As a result, the service person can efficiently perform maintenance on the image forming apparatus 10 while confirming the list including a plurality of pieces of the setting item information classified into the same piece of the classification information.

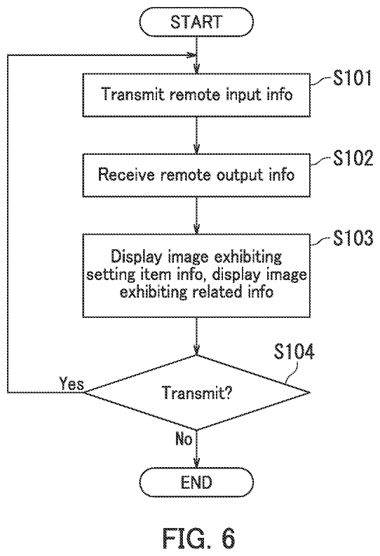

Continuing, a display method performed by the terminal controller 31 is described with reference to FIG. 6. FIG. 6 is a flowchart depicting the display method performed by the terminal controller 31. The display method includes Steps S101 to S104.

As depicted in FIG. 6, the terminal transmission section 34 transmits the remote input information to the image forming apparatus 10 in Step S101.

Next, in Step S102, the terminal reception section 35 receives the remote output information from the image forming apparatus 10 which received the remote input information.

Next, in Step S103, the terminal controller 31 controls the terminal display section 33 based on the remote output information. The terminal controller 31 displays the images 41B and 42B exhibiting the setting item information in the first region of the terminal display section 33, and displays the image 43B exhibiting the related information in the second region of the terminal display section 33.

Next, in Step S104, the terminal controller 31 determines whether or not the terminal operation section 36 has received the remote input information. When an affirmative determination (Yes) is made in Step S104, the process returns to Step S101. When a negative determination (No) is made in Step S104 by contrast, the process ends.

### Second Embodiment

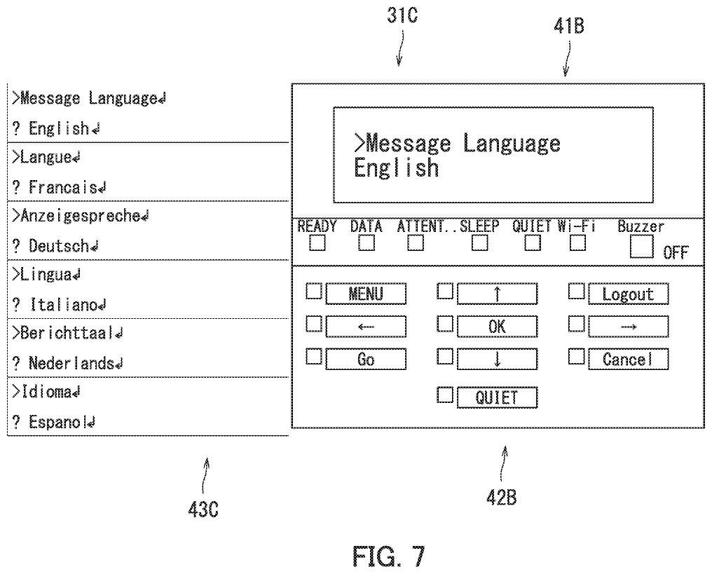

A configuration of the image forming system 100 according to a second embodiment of the present disclosure is described with reference to FIG. 7. FIG. 7 is a diagram illustrating an image displayed by the terminal display section 33. The image forming system 100 of the second embodiment differs in that the image exhibiting the related information is a list including a plurality of pieces of the selection candidate information. The following mainly describes points which differ from the first embodiment.

As illustrated in FIG. 7, an image 31C includes the image 41B exhibiting the setting item character information, and the operation image 42B. The image 31C also includes an image 43C exhibiting the related information.

The image 43C exhibiting the related information is displayed in the second region of the terminal display section 33. The image 43C exhibiting the related information is a list including a plurality of pieces of the selection candidate information.

The list including the pieces of the selection candidate information includes “English”, “Français”, “Deutsch”, “Italiano”, “Nederlands”, and “Espanol”.

As a result, the service person can efficiently perform maintenance on the image forming apparatus 10 while confirming the list including the pieces of the selection candidate information. For example, the service person can recognize in advance how many times to press the “down arrow” button to find a desired piece of the selection candidate information.

### Third Embodiment

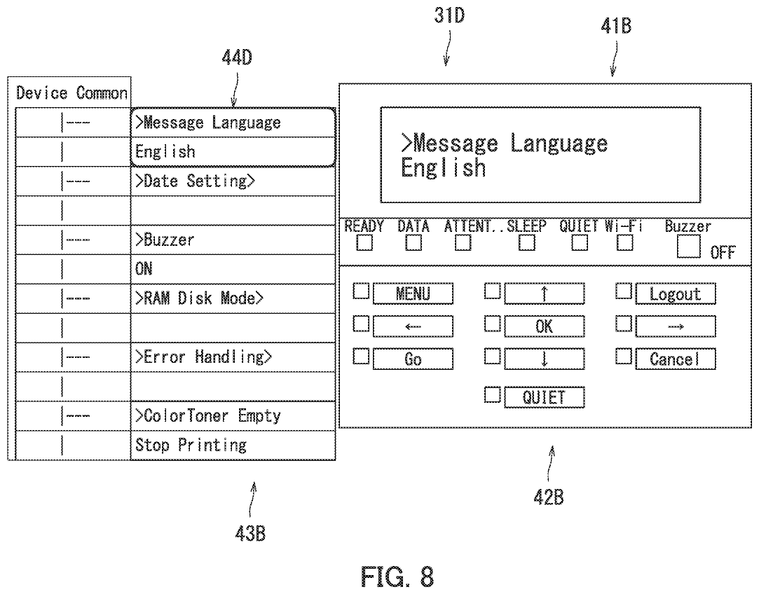

A configuration of the image forming system 100 according to a third embodiment of the present disclosure is described with reference to FIG. 8. FIG. 8 is a diagram illustrating an image displayed by the terminal display section 33. The image forming system 100 of the third embodiment differs in that visually identifiable information is attached to the image exhibiting the setting item information. The following mainly describes points which differ from the first embodiment.

As illustrated in FIG. 8, an image 31D includes the image 41B exhibiting the setting item character information, and the operation image 42B. The image 31D also includes the image 43B exhibiting the related information. The image 31D further includes visually identifiable information 44D.

The image 43B exhibiting the related information is displayed in the second region of the terminal display section 33. The image 43B exhibiting the related information is a list including a plurality of pieces of the setting item information classified into the same piece of the classification information, for example.

The list including the pieces of the setting item information includes “Message Language”, “Date setting”, “Buzzer”, “RAM Disk Mode”, “Error Handling”, and “ColorToner Empty”.

The terminal controller 31 attaches the visually identifiable information 44D to an image related to a piece of the setting item information for which the selection candidate information has changed. The visually identifiable information 44D is a thick border image, for example. Specifically, a thick border image is attached to “Message Language”. As a result, the service person can recognize that “Message Language” has a piece of the selection candidate information which has changed. Therefore, the service person can efficiently change the selection candidate information when the service person has changed the selection candidate information in the setting item information but wants to return to the selection candidate information from before changing the selection candidate information or wants to try another piece of the selection candidate information.

### Fourth Embodiment

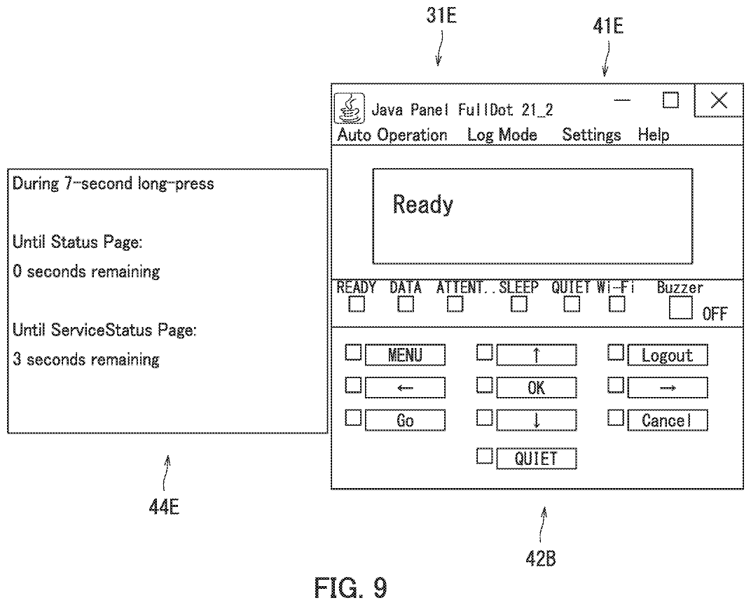

A configuration of the image forming system 100 according to a fourth embodiment of the present disclosure is described with reference to FIG. 9. FIG. 9 is a diagram illustrating an image displayed by the terminal display section 33. The image forming system 100 of the fourth embodiment differs in that the image exhibiting the related information exhibits a period of time for transition to an image exhibiting specific information. The following mainly describes points which differ from the first embodiment.

As illustrated in FIG. 9, an image 31E includes an image 41E exhibiting the setting item character information, and the operation image 42B. The image 31E also includes an image 44E exhibiting the related information.

The image displayed by the apparatus display section 111 of the image forming apparatus 10 transitions to the image exhibiting the specific information when a prescribed button of the terminal operation section 36 is long-pressed for a prescribed period of time. The image exhibiting the specific information exhibits “Status Page” or “ServiceStatus Page”, for example. A transition to “Status Page” is made by long-pressing the prescribed button for 7 seconds, and a transition to “ServiceStatus Page” is made by long-pressing the prescribed button for 10 seconds.

The image 41E exhibiting the setting item character information includes “Ready”, for example.

The image 44E exhibiting the related information is displayed in the second region of the terminal display section 33. The image 44E exhibiting the related information exhibits the period of time for transition to the image indicating the specific information, for example. The specific information indicates “Status Page” or “ServiceStatus Page”, for example. Specifically, the period of time for transition to the image indicating specific information includes “0 seconds remaining to Status Page” and “3 seconds remaining to ServiceStatus Page”. As a result, the service person can recognize the period of time for transition to the image exhibiting the specific information.

Embodiments of the present disclosure are described above with reference to the accompanying drawings. However, the present disclosure is not limited to the above embodiments and may be implemented in various manners within a scope not departing from the gist thereof. The drawings mainly illustrate constituent elements schematically for ease of understanding. Aspects such as thickness, length, and number of the constituent elements illustrated in the drawings may differ in practice for convenience of drawing preparation. Furthermore, aspects such as material, shape, and dimension of the constituent elements illustrated in the above embodiments are one example and not particular limitations. The constituent elements may be variously altered within a scope not substantially departing from the effects of the present disclosure.

(1) As described with reference to FIGS. 1 to 9, the terminal storage 32 stored the application AP, but the present disclosure is not limited as such. The storage 22 of the server apparatus 20 may also store the application AP. The controller 21 of the server apparatus 20 may execute the application AP.

(2) As described with reference to FIGS. 1 to 9, the image forming apparatus 10 is a color copier, but the present disclosure is not limited as such. The image forming apparatus need only form an image on the sheet 19. For example, the image forming apparatus may be a monochrome copier. The image forming apparatus may also be a multifunction peripheral, for example.

(3) As described with reference to FIGS. 1 to 9, the visually identifiable information was a thick border image, but the present disclosure is not limited as such. The visually identifiable information need only be visually identifiable. For example, the visually identifiable information may be a circle image, a red character image, or a blinking image.

What is claimed is:

1. An image forming system comprising:
an image forming apparatus; and
an information processing device configured to communicate with the image forming apparatus, wherein
the image forming apparatus includes an apparatus display section which displays an image,
the information processing device includes:
a terminal display section which displays an image;
a terminal transmission section which transmits remote input information to the image forming apparatus;
a terminal reception section which receives remote output information from the image forming apparatus that received the remote input information; and
a terminal controller which controls the terminal display section based on the remote output information,
the remote input information includes information which requests setting item information displayed by the apparatus display section and related information related to the setting item information,
the setting item information includes information which controls the image forming apparatus,
the remote output information includes the setting item information and the related information, and
the terminal controller controls the terminal display section so as to display an image exhibiting the setting item information in a first region of the terminal display section and display an image exhibiting the related information in a second region of the terminal display section.

2. A storage medium that stores a computer program therein, the computer program causing a computer that communicates with an image forming apparatus to execute:
transmitting remote input information to the image forming apparatus;
receiving remote output information from the image forming apparatus that received the remote input information; and
controlling the terminal display section based on the remote output information, wherein
the remote input information includes information which requests setting item information displayed by an apparatus display section of the image forming apparatus and related information related to the setting item information,
the setting item information includes information which controls the image forming apparatus,
the remote output information includes the setting item information and the related information,
in the controlling, an image exhibiting the setting item information is displayed in a first region of the terminal display section and an image exhibiting the related information is displayed in a second region of the terminal display section.

3. The storage medium according to claim 2, wherein
a shape of the apparatus display section is substantially the same as a shape of the first region of the terminal display section.

4. The storage medium according to claim 2, wherein
the setting item information is provided as a plurality of pieces thereof,
each piece of the setting item information is classified into one piece of classification information among a plurality of pieces of classification information, and
the image exhibiting the related information is a list including pieces of the setting item information classified into the same piece of the classification information.

5. The storage medium according to claim 4, wherein
the setting item information includes information indicating one piece of selection candidate information selected from among a plurality of pieces of selection candidate information, and
in the controlling, visually identifiable information is attached to an image related to a piece of the setting item information for which the selection candidate information has been changed in the list.

6. The storage medium according to claim 2, wherein
the image exhibiting the related information is a list including a plurality of pieces of selection candidate information, and
the setting item information includes information indicating one piece of the selection candidate information selected from among the pieces of the selection candidate information.

7. An image forming apparatus comprising:
an image forming section configured to form an image;
an apparatus controller configured to output setting item information;
an apparatus display section configured to display the setting item information;
an apparatus reception section configured to receive remote input information from an information processing device; and
an apparatus transmission section configured to transmit remote output information to the information processing device that received the remote input information, wherein
the information processing device includes a terminal display section which has a first region and a second region,
the remote input information includes information which requests the setting item information displayed by the apparatus display section and related information related to the setting item information,
the setting item information includes information which controls the image forming section, and
the remote output information includes an image exhibiting the setting item information displayed in the first region of the terminal display section and an image exhibiting the related information displayed in the second region of the terminal display section.
